(19) United States
(12) Patent Application Publication
(10) Pub. No.: US 2002/0095424 A1
(43) Pub. Date: Jul. 18, 2002

(54) Method for tracking patients

(76) Inventor: Chris Chung, Longwood, FL (US)

Correspondence Address: Wendy K.B. Buskop, Buskop Law Group PC, Suite 500, 1717 St. James Place, Houston, TX, 77056, US

(21) Appl. No.: 09/765,037

(22) Filed: Jan. 17, 2001

(51) Int. Cl. G06F 7/00

(52) U.S. Cl. 707/100

(57) ABSTRACT

A method and system for remotely tracking patient data via the use of handheld computers.

### BACKGROUND OF THE INVENTION

There has been a long need for doctors and hospital staff to have access while on rounds to their databases for a particular patient history and other medical databases, as well as a need for hospital administration and medical staff to know which patients are at what nursing stations in a hospital.

A handheld computing method has long been needed which can assist in the tracking of patients.

The present invention is a method which uses handheld computers to set up information that is specific to a particular nursing station with functionality that allows for the creation; review and printing of reports about an individual patient, including pharmacological information. Additionally, there has been a need for a device, which can store patient information and then “beam” that patient information from one handheld to another.

### SUMMARY OF THE INVENTION

A method and system for remotely tracking patient data via the use of handheld computers.

### BRIEF DESCRIPTION OF THE DRAWINGS

FIG. 1 is an exemplary first screen of the method, wherein data is selected by preferences, which can be the number of a nursing station or by the number of a doctor;

FIG. 2 is an exemplary Patient overview screen, which is a list of patients sorted by nursing station;

FIG. 3 is an exemplary individual patient information screen;

FIG. 4 is an exemplary allergy information screen;

FIG. 5 is an exemplary medication screen;

FIG. 6 is an exemplary medication detail screen;

FIG. 7 is an exemplary intravenous medication screen;

FIG. 8 is an exemplary screen for clinical notes on a patient; and

FIG. 9 is an exemplary screen for the screen that lets the user adds details on client intervention for a particular patient;

FIG. 10 is an exemplary drop down screen for adding clinical notes.

### DETAILED DESCRIPTION

Specifically, the invention relates to the use of a method on a handheld computer, or personal digital assistant (PDA), for tracking patient information.

The present invention provides a method and system whereby information on a particular patient and information in a database can be accessed while a doctor is on rounds or while medical staff is away from their personal computer or other existing information infrastructure.

There are three components that make up the novel method set up. The first component is on the main frame and is a one-time installation that is never changed or modified unless there is a system change. The second component is one that is called the conduit. The conduit configuration happens for each workstation that attaches to the main database and is used for synchronization operations such as HotSync® by Palm, Inc. The conduits are configured specifically for the novel method. The configuration is done during the installation of the software. It is an automatic install and automatic step up in the preferred embodiment. The third component is the program itself as installed on the handheld computer. After the installation runs and immediate synchronization is required to download all nursing station and clinical information to the handheld computer. Whenever a change occurs in the nursing station tables or the clinical information codes tables, it is going to be a requirement to delete the handheld application off the handheld and reinstall it. During the install process, it is preferred that the user enters a hospital number and a User ID. These two pieces of information are stored in the handheld and are not modified until the handheld application is removed and reinstalled. These two pieces of information are critical for both the upload as well as the download of information to and from the main database. The hospital codes are very important and used for the upload of any new clinical notes during use of the program. Whenever a clinical note is added, the User that was keyed during set up is appended to the record and sent back to the main database.

Patient information which is available to the medical staff via this method can include a list of (1) patient details; (2) medications used, (3) clinical interventions used, and an the inventory of (4) patients assigned to a specific doctor, nursing station or other appropriate code, and (5) access to the medications database and information on drugs and procedures.

Software Features

After initial installation, the method permits patient data to be downloaded to a handheld computer by a selected number of nursing stations, or by a selected number of doctors, identified by their physician identification numbers. After selecting one or more doctors, or one or more nursing stations, the user is prompted to actuate the save button, which prompts the user to perform a synchronization for the desired data. The synchronization process will then go out to the database and download all of the patients that match the nursing stations or doctor codes which were selected. The data of the downloaded patients can then be viewed by the user on the handheld computer. Once the download is completed, further patient tracking can occur.

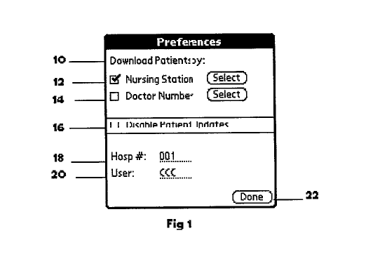

As shown in FIG. 1, the user would initially enter a preference for downloading patient data 10. In this embodiment, the preference would most preferably be between nursing stations 12 and doctor codes 14. In addition, the same screen could show a daily synchronization reminder 16, to remind the user to do the daily synchronization to download data from a database to the handheld computer. Further, the hospital or station code where the patients are physically located 18 could be entered, and the pharmacy code 20 could be entered. When the user has finished selecting the preferences, the user could contact the done button 22.

Depending on which number is entered, the doctor codes screen could pull down a list of doctor codes to choose from, such a list might list the doctors by name, either last name or first name, or by their specialty. If the nursing station code 12 was selected, a list of nursing stations would appear to view and choose from. A user could select one or more doctor codes or nursing station codes from this first preference screen. The user could cancel this screen of choices or save the choices for the next step of the invention.

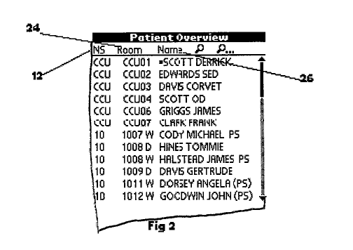

FIG. 2 shows a patient overview screen. This screen is the result of the download of the one or more doctor or nursing codes. Initially this screen should provide the selected code, such as the nursing station number 12, the room number or location of the patient 24, and the name of the patient 24. In this method, the user can then click on a particular patient name for more information.

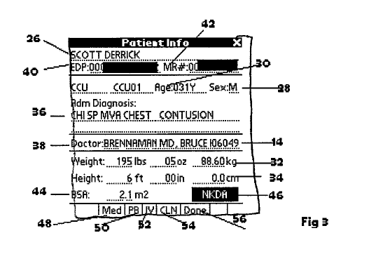

By tapping on one of the patients, a patient information screen is presented, as shown in FIG. 3, which includes patient information, such as patient's name, 26, patient's sex 28, patient's date of birth or age 30, patient's weight 32, patient's height 34 height and admitting diagnosis 36.

Additionally, the consulting physician 38 can be included with the doctor code 14. Additional patient information such as an account number (EDP) number 40, a medical record number (MR) number 42 , a body surface analysis (BSA) code 44 can appear on this screen as well as the selected doctor or nursing code.

Choices for more information on this patient are also presented to the user; these choices may include allergies 46. Navigation buttons are noted on the bottom of the screen. The navigation button includes medicines 48, Piggybacks 50, intravenous medicines 52, and clinical intervention notes 54. When the user is finished, a done button 56 can be used to terminate inputs on this screen.

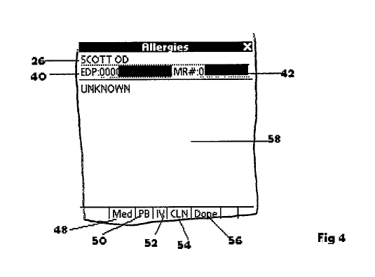

If allergies are selected, then a screen similar to the one in FIG. 4 is displayed. On the allergy screen, data can appear such as patient name 26 and the EDP number 40, as well as the MR number 42. Also a field screen 58 can be displayed onto which the user or the database input clerk could enter the appropriate information on allergies, such as “Patient is Diabetic.” Navigation buttons med., 48, Piggy backs 50, INTRAVENOUS 52, CLN 54 and Done 56 can appear on the bottom of this screen to aid in user use.

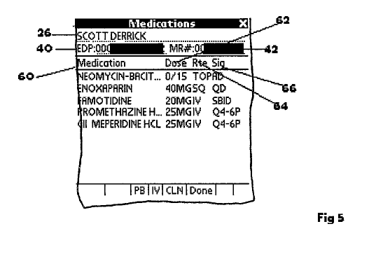

FIG. 5 depicts a typical screen when the medication button has been engaged. On this screen, we see the patients' name 26, EDP number 40 and MR 42, but we also see a list of medications 60 with the dose 62 for each medication, the route of medication (Rte) 64, and the dosage frequency (SIG) 66. This list is the list of all mediations the patient is on starting with the most recent order and all currently active orders on that patient.

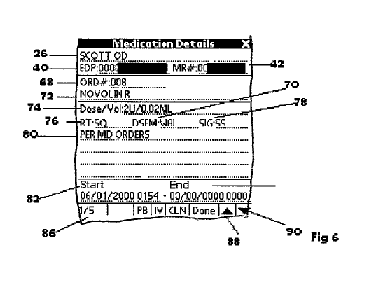

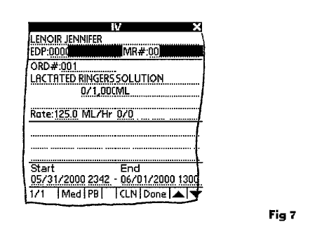

FIG. 6 shows the detail screen for the patient medications, which appears after selecting a particular order. In the preferred embodiment, this screen includes fields for the patient name 26, the EDP 40 and the MR 42, and order number 68 and the dosage format 70 (such as a tablet or via) the drug name 72, which includes details of the dosage. Information on the dose and volume of the dose 74 can be included on this screen as well as the RT 76, the SIG 78, the purpose of the medication 80, the start date of with medicine 82 and the end date of the medicine 84 can appear on the screen. Additionally, the medication sequence counter 86, can appear on the screen as well as up 88 or down 90 navigation buttons and other navigation buttons, such as INTRAVENOUS, PB, CLN and Done. FIG. 7 shows the INTRAVENOUS screen, which has the same details as the Medication screen. The piggyback screen also will have the same details.

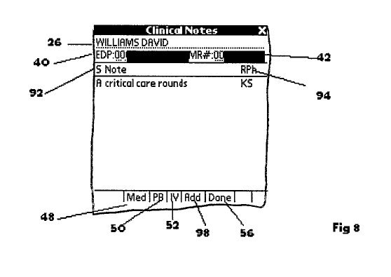

FIG. 8 shows an exemplary screen if the CLN button is selected. The screens can be ordered from oldest to newest. Typical notes will have the patient name 26, EDP number 40, MR number 42, an area to provide the status of the clinical note (S note) area 92, and the pH 94 with a field area 96 for adding data on a patient. Additionally, navigation buttons can be inserted on this screen, including but not limited to Med. 48, PB 50, Intravenous 52, Add 98 and Done 56. 20

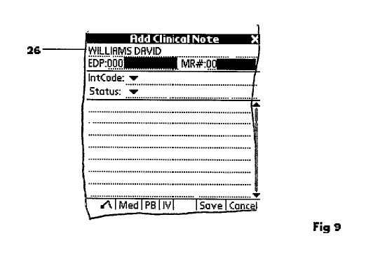

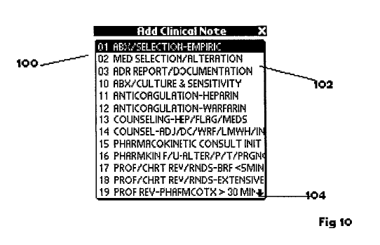

FIG. 9 shows an exemplary screen if the ADD button 98 is selected. An ADD button 98 allows the user to add additional notes to a patient profile, which has the name 26, and other patient data listed. Navigational buttons can be used on this screen as well as the save and cancel features. It is also within the scope of the invention that the clinical intervention codes be viewable and selectable from a drop down list as shown in FIG. 10. FIG. 10 shows the clinical intervention codes 100 with the accompanying text 102 and “more” notes 104. Once the notes have been added, a hot-sync is required to upload the notes back to the main patient database. It is preferred that this step be performed with a standard synchronization. If there are no changes in the preferences, the data will be uploaded and a fresh download will be performed for the same nursing stations and doctors, which were previously selected. The notes will against be downloaded and the screen should include the new notes.

In the method of this invention, it is critical to upload all notes at least once a day at the end of business. The notes are date and time sensitive and for this reason, if they are uploaded on a daily basis, they will benefit the rest of the pharmacists who may want to download the same patient and do rounds that evening or the next morning. If the notes and data are synchronized on a daily basis, that guarantees that the next download will have those notes included. This only improves accuracy as far as patient care. Another reasons for the daily synchronization is the fact that the patient's status and information change regularly and this may be the only way to get the most recent patient profile information.

Portable Computer Characteristics

Computer Screen:

The software is designed so that the medical staff sees the data entry information in the form of check boxes/pick lists on the screen. All medical reports are revisable in total on the screen. It is contemplated that the device can “beam” updates to medical reports to another portable or handheld computer.

The portable computer should also have a set of pre-selected components which “boot up” with the system which includes:

1. Medical staff s name (user name)

2. Medical staff's identification number

3. Medical staff's current day and time

4. Medical staff's location

In this invention, the preferred embodiment is a flexible, portable way to update medical reports in the field by a doctor or similar medical staff member.

It extends the mobile computing environment previously inaccessible to many pharmacists.

It is also contemplated that the device when engaged to a portable printer should enable a medical staff member to print medical reports in the field. It is contemplated to have an optional eXtensible Markup Language (XML) based integration with back end main medical or hospital database systems.

Handheld devices within the scope of the novel invention are contemplated as Palm III™, Palm IIIx™, Palm IIIxe™, Palm IIIe™, Palm IIIc™, Palm V™, Palm Vx™, Palm VII™, and Palm VIIx™, Handspring Visor™ and Sony CLIE™. A preferred portable printer that is considered usable here is Monarch 6015. 5

In another preferred embodiment, the device can be used in refugee or disaster camps to assist in serving many people in one location, where desktop PC input would be impossible or impractical. The handheld will allow medical staffs to capture data on all encounters with patients while in the field and have that data incorporated into local, regional and national databases.

Additional features can be added to the system, such as means to specify the number of copies of the medical report to print and password access only for the user of the system.

The invention is a system that endeavors to be flexible yet very powerful in the functionality that it provides in an effort to allow one to improve upon and enhance one's core line of business.

The invention requires two basic users, a System Administrator responsible for day-to-day administration of the database. The primary system interfaces for the System Administrator will be a Synchronization Server and a Handheld Initialization Tool. The other individual is the medical staff member in the field using the product to enhance and improve day-to-day activities. The primary system interface for the medical staff member will be the handheld software.

It is contemplated that the most preferred system has server software that runs on any hardware platform supporting the Windows operating system. The server software will run on Windows 95, Windows 98, Windows^{NT} and Windows 2000. The handheld software will run on the Palm OS® version 3.1 and higher. A Monarch 6015 printer will be utilized for printing services. The Synchronization Server will operate as a Windows System Tray program or as a service. The synchronization server will be responsible for transferring information off of the handheld computer to the server via an XML document or some other type of automated computer interface. Additionally, the synchronization server shall be responsible for updating the reference data on the handheld units as necessary. The Handheld Initialization Tool will operate as a Windows program and shall allow for an administrator to install and configure multiple handheld devices. Default values for the system shall be configurable through the initialization tool or via common tools such as Microsoft Excel.

The present invention relates to a method for updating medical patient records comprising a unique personnel code for each medical staff unit in the field;

providing at least one main computer having at least one central processing unit with data storage and retrieval components;

providing a plurality of handheld transceivers each possessing a unique identification code, and password and each further having a visual display screen, a power source, and a plurality of user selectable input mechanisms;

providing a plurality of synchronization means for receiving, and transmitting data from the handheld transceivers, and wherein each of said plurality of synchronization means communicates with said at least one main computer and with any number of said plurality of handheld transceivers;

analyzing data contained within the data storage component of the at least one main computer to determine which patient records are associated with the personnel codes;

transmitting a signal from said at least one main computer to the transceiver to upload the medical patient data files; and

allowing said medical staff unit to update those files on a real time basis.

The invention also includes a system for the manipulation and display of patient records. a system for manipulation and display of medical files, comprising: a computer system; a handheld image display units comprising a main viewer associated with said computer; wherein said handheld image display unit is: a handheld computer consisting of an image display control; display of medical image files; means for communicating commands for controlling display of image files; said image display control having multiple functions, at least some of said functions of said image display control being accomplished through commands generated by actuation of one or more switch elements, the particular control function provided by a switch element or combination of switch elements; and means for displaying a series of different medical image files in said main viewer, said displaying means displaying said image files one file at a time in a serial order during at least an initial display of said image files.

The invention is also a computer network for gathering data related to the medical patients in a hospital, wherein the hospital has at least one nursing station and an operations base, and the network comprises a first, mobile computer adapted for being carried in the field and having a graphic user interface to facilitate the entry of data therein, a second fixed platform computer adapted for location at a operations base and configured to emulate the graphic user interface of the first computer so that an operator may conveniently operate both the first and second computers with substantially the same commands, and a first data link for selectively connecting the first and second computers

These and other embodiments of this invention will become apparent from the appended claims.

What is claimed is:

1. A method for electronically updating a medical patient records comprising:
providing a unique personnel code for each medical staff unit in the field;
providing at least one main computer having at least one central processing unit with data storage and retrieval components;
providing a plurality of handheld transceivers each possessing a unique identification code, and password and each further having a visual display screen, a power source, and a plurality of user selectable input mechanisms;
providing a plurality of synchronization means comprising means for receiving, and transmitting transmissions from the handheld transceivers, and wherein each of said plurality of synchronization means communicates with said at least one main computer and with any number of said plurality of handheld transceivers;
analyzing data contained within the data storage component of the at least one main computer to determine which patient records are associated with the personnel codes;
transmitting a signal from said at least one main computer to the transceiver to upload the medical patient data files; and
allowing said medical staff unit to update those files on a real time basis.

2. The method according to claim 1 comprising the additional steps of:
monitoring all handheld transceivers and continuously updating transceivers on a wireless basis and on a daily basis basis.

3. The method according to claim 1 further comprising the additional step of providing at least one automated transceiver distribution mechanism.

4. The method according to claim 1 further comprising the additional step of providing at least one automated transceiver testing mechanism for testing transceivers for operational integrity.

5. The method according to claim 1 farther wherein selecting any one of said patients further comprises the additional steps of:
depressing any one of said user selectable input mechanisms;
scrolling through each patient information displayed upon said visual display screen; and
selecting the appropriate information by depressing another of said user selectable input mechanisms.

6. A computer network for gathering data related to the medical patients in a hospital, said hospital having at least one nursing station and an operations base, said network being comprised of a first, mobile computer adapted for being carried in the field and having a graphic user interface to facilitate the entry of data therein, a second fixed platform computer adapted for location at said operations base and configured to emulate the graphic user interface of said first computer so that an operator may conveniently operate both said first and second computers with substantially the same commands, and a first data link for selectively connecting said first and second computers.

7. The computer network of claim 6, further comprising a plurality of computer pairs, each of said pairs being comprised of a first computer, a second computer, and a first data link for selectively connecting said first and second computers.

8. The computer network of claim 6, wherein each of said first computers includes a memory for storing data relevant to the individual patient in said hospital.

9. The computer network of claim 6 wherein said graphic user interface includes a screen, said first computer being configured for an operator to selectively display said relevant data in any one of a plurality of formats on said screen.

10. The computer network of claim 6 wherein said second computer is configured for manipulating the data stored in said first computer's memory through said first data link.

11. The computer network of claim 6 wherein said second computer includes a memory for storing at least said relevant data stored in said first computer, and is configured for synchronizing said relevant data as stored in said memories.

12. The computer network of claim 6 wherein said second data link comprises a messaging service.

13. A portable, handheld computer for gathering and processing substantially all material data related to a patient in a hospital through an entire hospital stay, said portable computer having a graphic user interface to facilitate the entry of, processing, and access to said data in said computer, a memory for storing said data, and a stored program to provide the interactive organized visual display of said data in a variety of formats upon operator command, processing of said data in response to operator inquiry including sorting of said data, and recording of operator comments relating to future desired actions to be implemented in said hospital.

14. The portable computer of claim 13 wherein said stored program is configured for synchronizing the data stored in said portable computer with the data stored in a second computer with a small number of fixed commands.

15. The portable computer of claim 13 wherein said stored program is configured for synchronizing the data stored in said portable computer with the data stored in a second computer upon connection there between with said electronic connection means.

16. The portable computer of claim 14 wherein said stored program is configured for displaying a plurality of nested shell displays on a screen, at least some of said displays including a plurality of data storage lines and a scrollable list from which an appropriate data entry may be selected for entry and display in one of said data storage lines.

17. The portable computer of claim 13 wherein said stored program is configured for populating a plurality of scrollable lists solely with entries which are properly selectable in response to the data already stored in said portable computer.

18. The portable computer of claim 13 further comprising a connector for connecting said portable computer to a second data base, said second data base being adapted for storing a significantly greater amount of data than may be stored in said portable computer memory.

18. The portable computer of claim 13 wherein a substantial portion of said data may be entered in said portable computer by physically touching said data entry as it is displayed on said graphic user interface to thereby provide simplified data entry for an operator.

19. The portable computer of claim 13 further comprising a touch screen sized to cover substantially the entirety of said portable computer's largest side.

20. In a computer network including a plurality of field computers, each of said field computers being adapted for creating a data base reflecting all activity related to a patient in a hospital, and a single central computer for receiving and assembling data from said field computers into a master data base, the improvement comprising an offline, batching data link interface between said field computers and said central computer to facilitate the orderly transfer of data between said computers.

21. The computer network of claim 20 wherein said central computer is adapted for retrieving messages addressed to it and stored in said data link, and for depositing messages in said data link intended for any of said field computers.

22. The computer network of claim 20 wherein each of said field computers is adapted for checking said data link for messages intended for it, and wherein said data link conditions the release of said messages upon the transmission by said field computer of its data to said data link addressed for said central computer.

23. The computer network of claim 20 wherein each of said field computers comprises a portable computer, a base operations computer, and a second data link for selectively connecting and transmitting data between said portable and base operations computers, said base operations computer being connected to said central computer through said batching data link.

24. A client-server computer network for collecting and analyzing data related to the medical procedures used on one patient in a plurality of hospitals comprising a plurality of computer sub-networks linked to a central server computer, each of said sub-networks being comprised of a portable computer for use by an operator in a field environment, a base operations computer comprised of a fixed platform PC, and a client data link for interconnecting said portable computer with said PC, each of said sub-networks being associated with a hospital, and a server data link interconnecting each of said sub-networks to said central server computer.

25. The computer network of claim 24 wherein each of said sub-network computers includes a memory for storing said hospital data and each of said PCs is configured for synchronizing data stored therein with data stored in its associated portable computer by storing the most recent data entry in any data pair.

26. A portable, handheld computer for gathering substantially all material data related to the treatment of a particular patient in a hospital through an entire hospital stay, said portable computer having a non-command line interface to facilitate the entry of said data into said portable computer, a memory for storing said data, and a stored program to provide the organized visual display of said data, said stored program being display driven and including a first set of displays for recording data on hospital procedures, a second set of displays for recording data on the patient itself, and a third set of displays for recording data the medical staff unit serving the patient.

27. The portable computer of claim 26 further utilizing a synchronization for connecting said portable computer to a second computer to facilitate the transmission of data there between.

28. The portable computer of claim 26 wherein said stored program is configured for having the data stored in said portable computer synchronized with a data set stored in said second computer.

29. A method for collecting and storing data relating to the medical procedures performed on a patient from a plurality of hospitals, each of said hospitals having an associated portable computer and fixed platform computer, comprising the steps of:
recording on each portable computer the data related to its associated hospital;
communicating the data from each of said portable computers to its associated computer; and
transmitting the data from each of said computers over an offline, batched data link to a central computer.
